(19) United States
(12) Patent Application Publication
(10) Pub. No.: US 2007/0114756 A1
(43) Pub. Date: May 24, 2007

(54) System & method to improve the fuel efficiency and engine life of a vehicle

(76) Inventor: Armen Shagbazyan, Glendale, CA (US)

Correspondence Address: Wilson Daniel Swayze, Jr, 3804 Clearwater Ct., Plano, TX, 75025, US

(21) Appl. No.: 11/253,591

(22) Filed: Oct. 19, 2005

(51) Int. Cl. B62D 53/08

(52) U.S. Cl. 280/405.1

(57) ABSTRACT

A system for automatically adjusting load distribution through axles of a truck and trailer assembly having a pair of rear wheels, the system includes a bridge section having a width, a length, a plurality of bridge legs coupled to it using a coupling apparatus, a central hole bolted to a hook using a hook nut and a hole nearing each corner, a pair of short frames running parallel to the bridge width and being connected to the bridge through said coupling apparatus, a pair of long frames running alongside the short frames, having a plurality of holes equinumber to said plurality of bridge legs, the holes configured to receive the bridge legs, the bridge legs being tightened to the holes using tightening means at an end opposite to the bridge, the long frames being free-floating frames, a pair of airbags seated on top of the long frames, a pair of hydraulic jacks placed inside the long frames, the pair of airbags and hydraulic jacks control the free-floating of the long frames, an air tank or a hydraulic pump for inflating or deflating the airbag or said hydraulic jack and a controller configured for monitoring the load distribution across the axles and inflates/deflate the airbag or hydraulic jack thereby automatically adjusting load distribution across the truck and trailer assembly.

### FIELD OF THE INVENTION

The present invention relates to trucks and trailers and more particularly to an apparatus for distributing load.

### SUMMARY OF THE INVENTION

The present invention provides an apparatus and method to improve the fuel efficiency and engine life of a vehicle, and more particularly, the present invention provides a system and method for improving the fuel efficiency and engine life of a truck and trailer. The present invention provides a system for automatically adjusting and spreading out load of a truck and trailer on a bridge between the truck and trailer assembly thereby very less pressure/stress put to the engine resulting in fuel savings and longer engine life.

The present invention provides for cost effective fuel energy saving apparatus which helps in reducing environmental pollution, increasing engine life of a vehicle, economy growth, less cost of transportation and low maintenance cost of vehicle. The present invention provides a system and method for improving the fuel efficiency and increasing the engine life of a truck and trailer. In effect, the load of the truck and trailer is spread out on the junction or bridge between the trailer and the cab rather than it sitting on the rear wheels of the main cab of the truck. In one truck embodiment, there is very less pressure (stress) put to the engine resulting in fuel savings and longer engine life. In exemplary embodiments of the present invention, the second axle is not powered, and the load sits between the axles on a platform. The weight of the load is in effect distributed across multiple points on the cab of the truck. In a prior art, all pressure is on the rear tires and axle which acts as a trailer.

### BRIEF DESCRIPTION OF THE DRAWINGS

The invention may be understood by reference to the following description taken in conjunction with the accompanying drawings, in which, like reference numerals identify like elements, and in which:

FIGS. 1A to 1K illustrate a system for automatically adjusting load distribution through axles of the truck and trailer assembly;

FIGS. 2A to 2R illustrate another embodiment for the system for automatically adjusting load distribution through the axles of the truck and trailer assembly; and

FIGS. 3A to 3H illustrated another embodiment for the system for automatically adjusting load distribution through the axles of the truck and trailer assembly.

### DETAILED DESCRIPTION OF THE INVENTION

The exemplary embodiments described herein detail for illustrative purposes are subject to many variations, structure and design. It should be emphasized, however that the present invention/description not being limiting to a particular system for improving the fuel efficiency and engine life of a vehicle/truck and trailer by automatically adjusting and distributing load across a truck and trailer assembly shown and described. Rather, the principles of the present invention can be used with a variety of truck and trailer assembly configurations and structural arrangements. It is understood is that various omissions, substitutions of equivalents are contemplated as circumstances may suggest or render expedient, but is intended to cover the application or implementation without departing from the spirit or scope of the claims of the present invention.

The present invention provides an apparatus and method to improve the fuel efficiency and engine life of a vehicle, and more particularly, the present invention provides a system and method for improving the fuel efficiency and engine life of a truck and trailer. The present invention provides a system for automatically adjusting and spreading out load of a truck and trailer on a bridge between the truck and trailer assembly thereby very less pressure/stress put to the engine resulting in fuel savings and longer engine life.

The present invention provides for cost effective fuel energy saving apparatus which helps in reducing environmental pollution, increasing engine life of a vehicle, economy growth, less cost of transportation and low maintenance cost of vehicle. The present invention provides a system and method for improving the fuel efficiency and increasing the engine life of a truck and trailer. In effect, the load of the truck and trailer is spread out on the junction or bridge between the trailer and the cab rather than it sitting on the rear wheels of the main cab of the truck. In one truck embodiment, there is very less pressure (stress) put to the engine resulting in fuel savings and longer engine life. In exemplary embodiments of the present invention, the second axle is not powered, and the load sits between the axles on a platform. The weight of the load is in effect distributed across multiple points on the cab of the truck. In a prior art, all pressure is on the rear tires and axle which acts as a trailer.

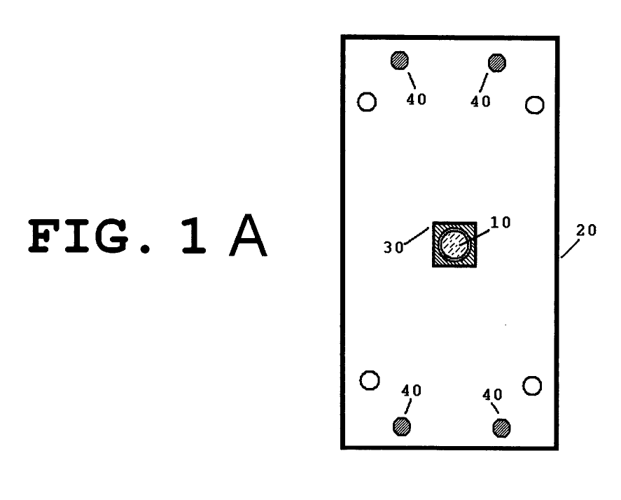

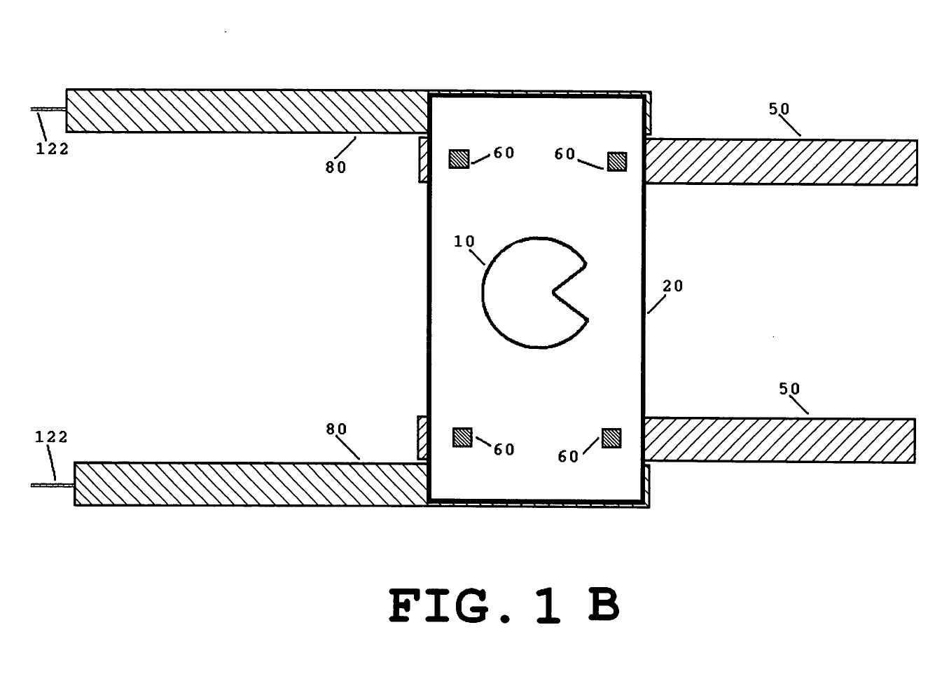

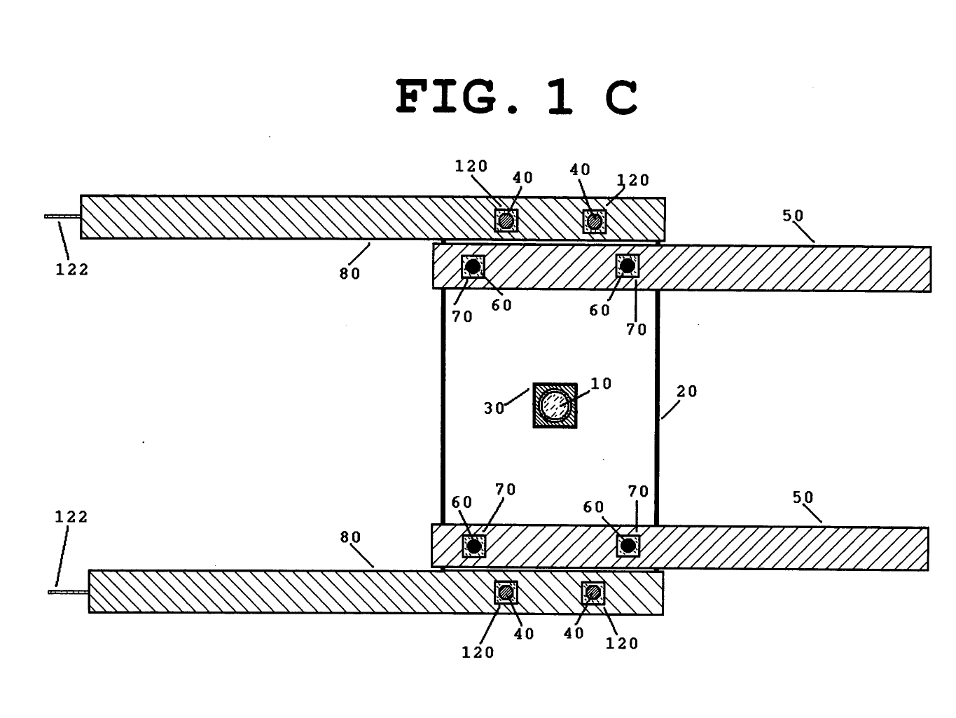

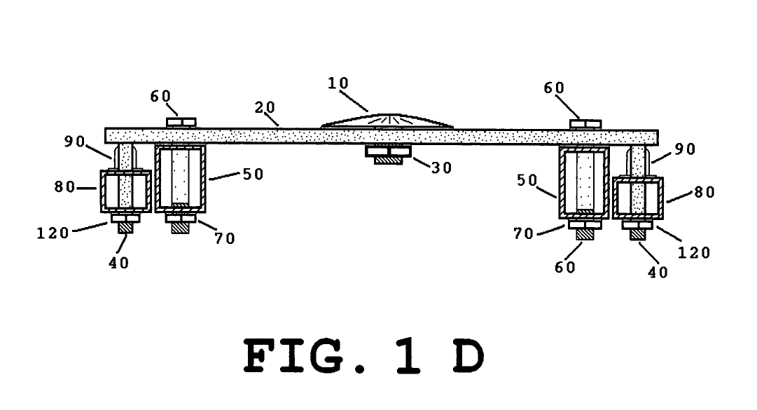

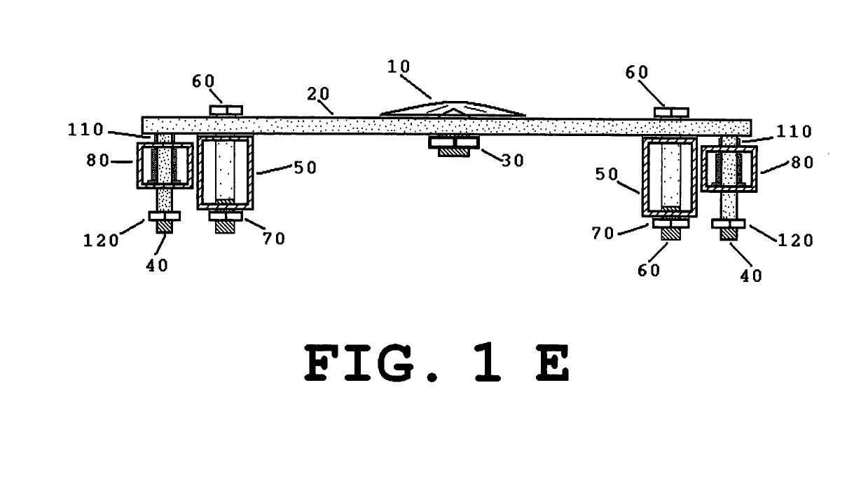

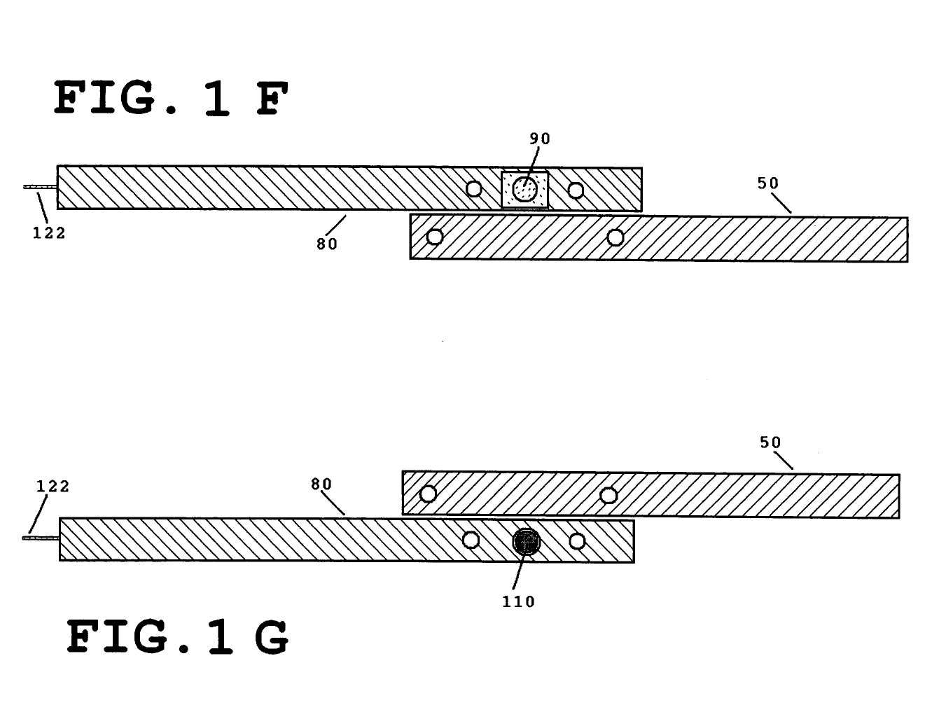

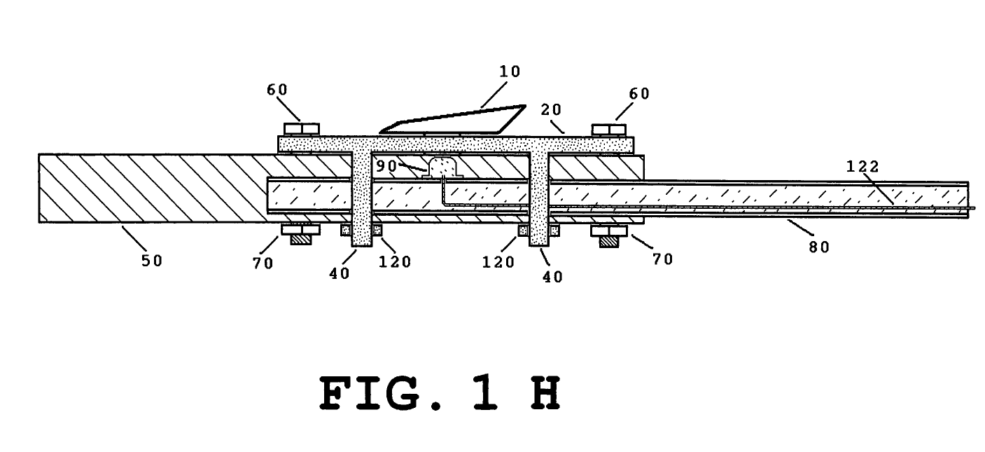

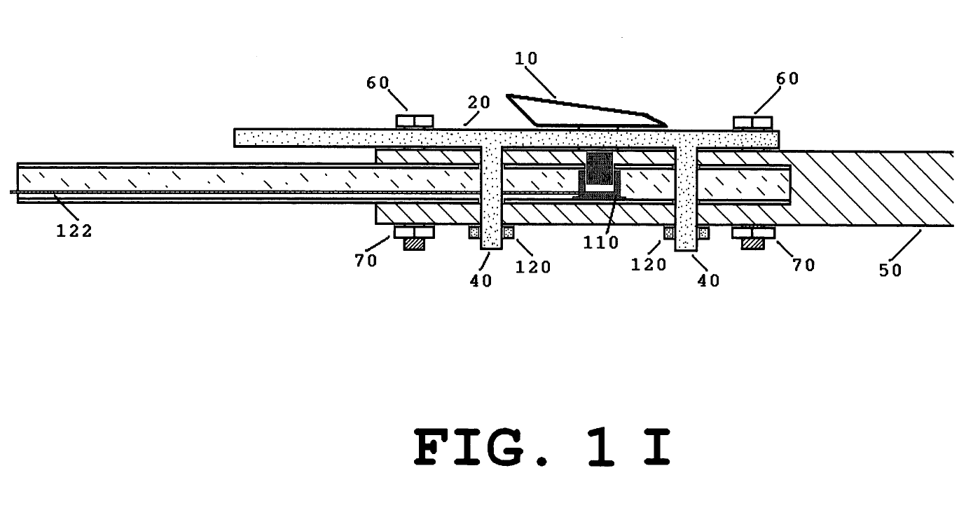

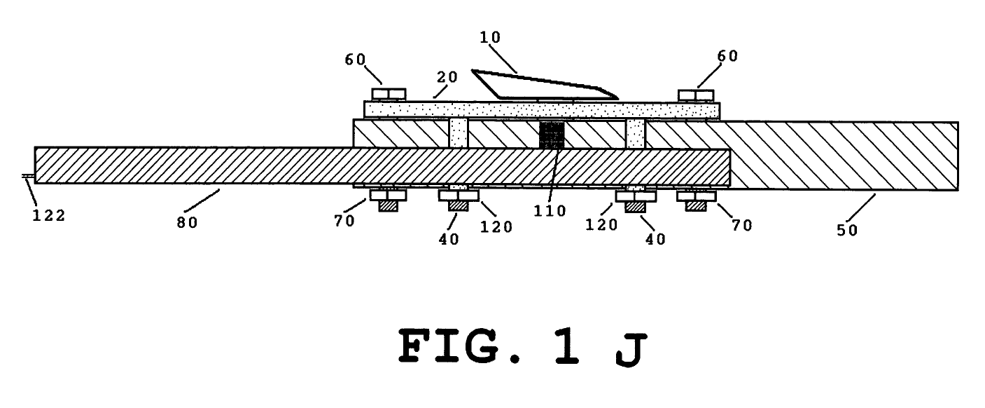

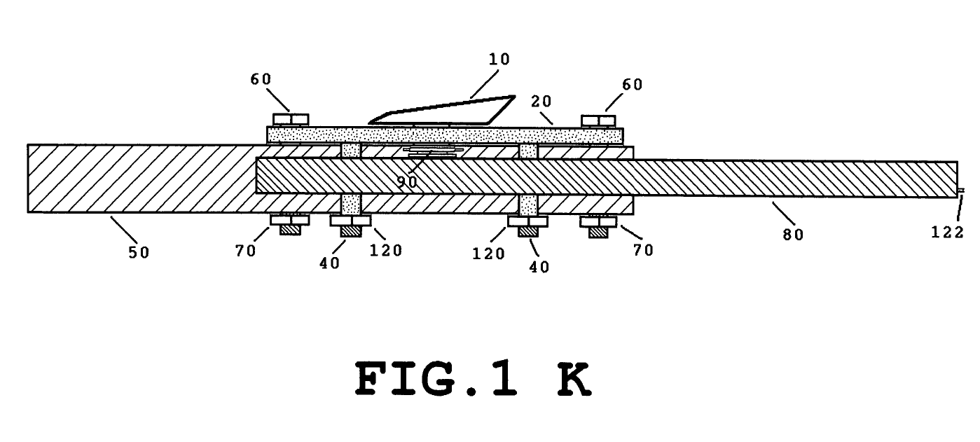

FIGS. 1A to 1K illustrate an exemplary embodiment of the present invention profile wherein the system 100 for automatically adjusting load distribution through axles of the truck and trailer assembly has been explained in detail. In an embodiment, as shown in FIG. 1A, the system 100 comprises a bridge 20 having specific width and length and has five holes, one at the center and one at each corner. A hook 10 is bolted at the center hole with a hook nut 30. The bridge 20 is provided with a similar bridge legs 40 at each corner coupled to with connecting means. The connecting means may include threads configured on each bridge leg 40 to be threaded onto said bridge holes having corresponding opposite threads. In another embodiment, the bridge 20 and the bridge legs 40 may be one piece metal or the like.

A pair of short frames, left short frame and right short frame 50 run parallel to the bridge 20 and are connected to the bridge 20 by connecting means. The connecting means may include bolts 60 and nuts 70. In another embodiment, the bridge 20 may also be welded with the short frames 50 or may be one piece metal or the like. A pair of long frames, left long frame and right long frame 80 is provided that run alongside the corresponding short frames 50.

The long frames 80 have a plurality of holes equal in number to the bridge legs 40 and received the same and are tightened to the holes using tightening means at an end opposite to the bridge 20. The tightening means may include nut screws 120 for screwing the long frames 80 with the bridge legs 40 and prevents the separation of long frames 80 from the bridge legs 40. The long frames 80 are free floating frames. In the system 100, pairs of airbags 90 are seated on top of the long frames 80. Also, pair of hydraulic jacks 110 is placed inside the long frames 80. The pair of airbags 90 and the hydraulic jacks 110 controls the free floating of long frames 80. The airbags 90 and electronic jacks 110 may be bolted or welded or glued the with a long frames 80. The system 100 is also provided with an air tank 124 and a hydraulic pump made of known state of the art technology for inflating the airbag 90 or the hydraulic jack 110. A controller is also as provided in the system 100 that monitors the load distribution along the axles of the truck and accordingly inflates/deflates the airbag 90 or hydraulic jack 110 and automatically adjusts the load distribution across said truck and trailer assembly. Accordingly, the load of the truck and trailer assembly is spread out on the bridge 20 between the truck and trailer rather than it sitting on the rear wheels of the truck.

In another embodiment, the system 100 may be made by cutting an existing frame in half and assembling components onto the two halves thereby the system 100 may be adapted to existing multi-axle trucks. During the passage of the vehicle going up hill or down hill, the controller inflates/deflates the airbags 90 or the hydraulic jacks 110 using the air tank 124 and the hydraulic pump 126 to transform or equalize the load on the wheels of the truck and trailer for traction thereby automatically adjusting load distribution.

FIG. 1B shows the top view of the system 100 depicting the bridge 20 along with the short frames 50 and the long frames 80 it shows the four bolts 60 that connect the short frames 50 to the bridge 20. It shows the hook 10 from the top view. A pair of long frames 80 can be seen running parallel to the short frames 50 and along the width of the bridge 20.

FIG. 1C is further a bottom view of the system 100 showing the configuration of the bridge 20 along with the components thereof. The FIG. 1C shows the hook 10 connected to the bridge 20 by the hook nut 30. Also seen are the bridge legs 40 connected at which the long frames 80 are connected using nuts 120 for holding the long frames 80. FIG. 1D shows the bridge 20 and the various nut holes at which the short frames 50, the long frames 80 and the hook 10 are connected.

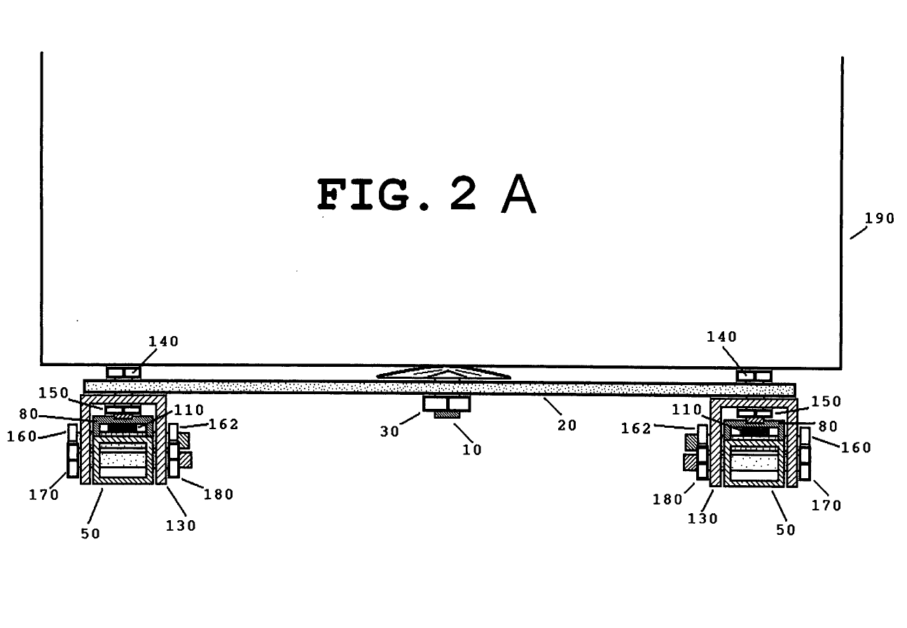

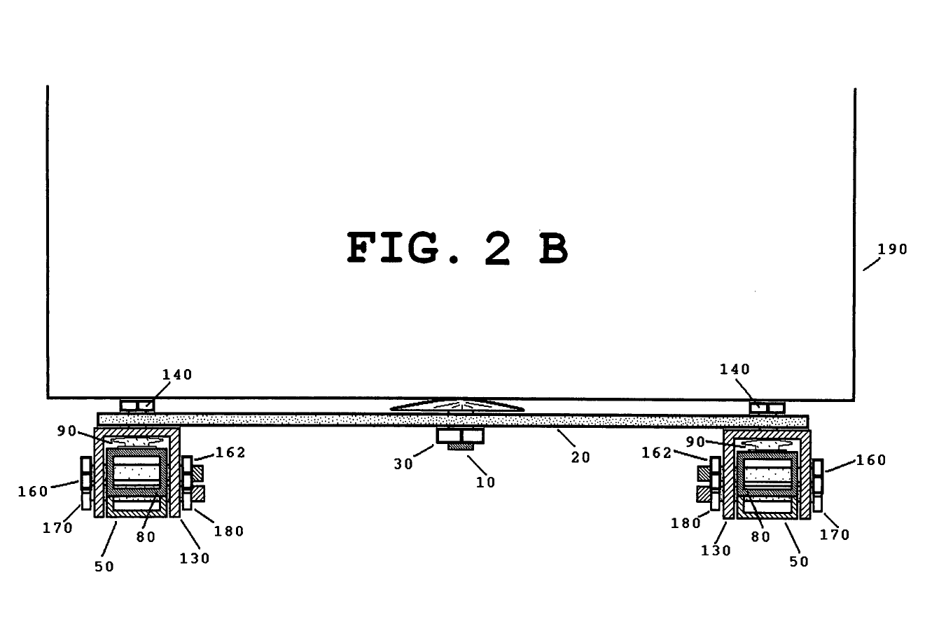

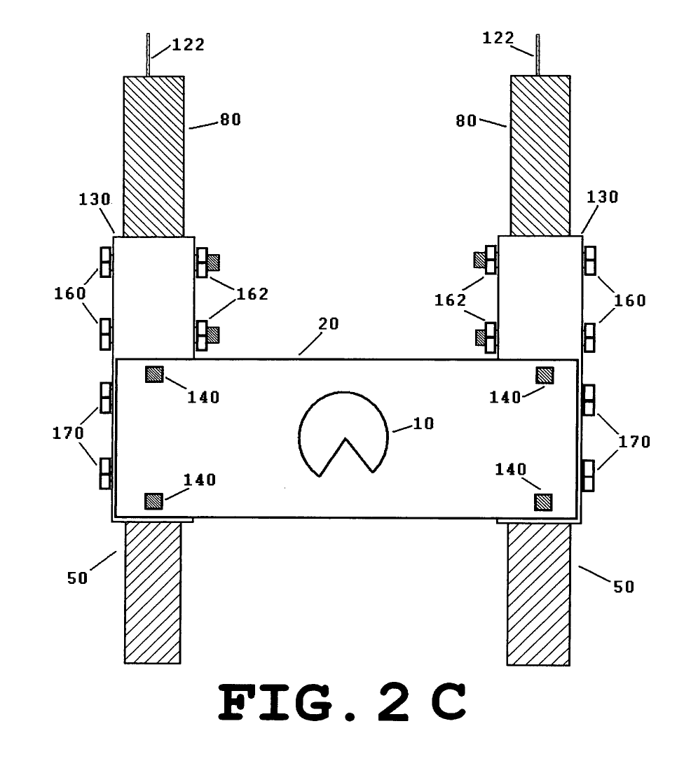

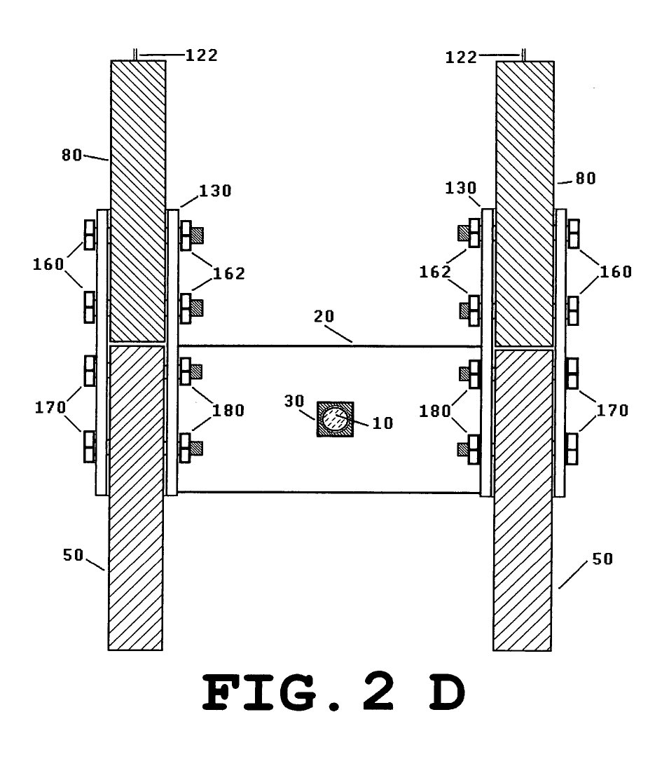

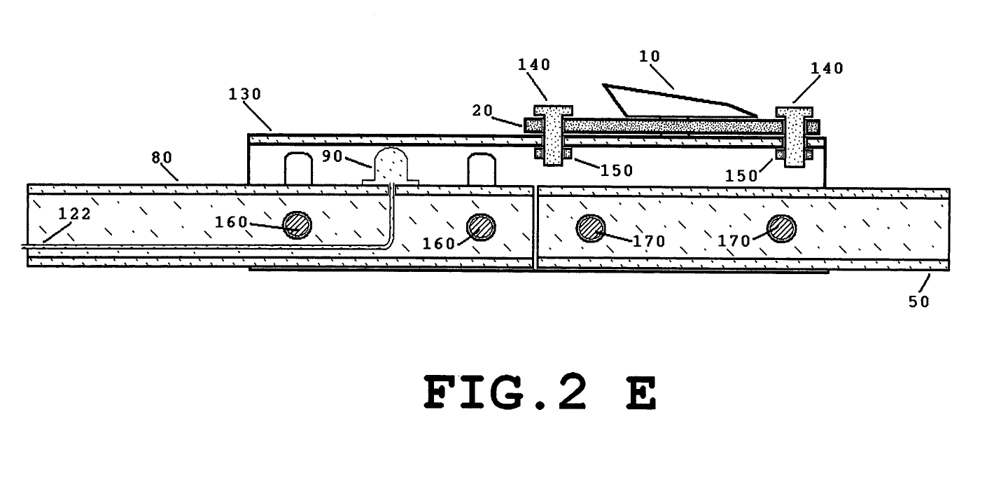

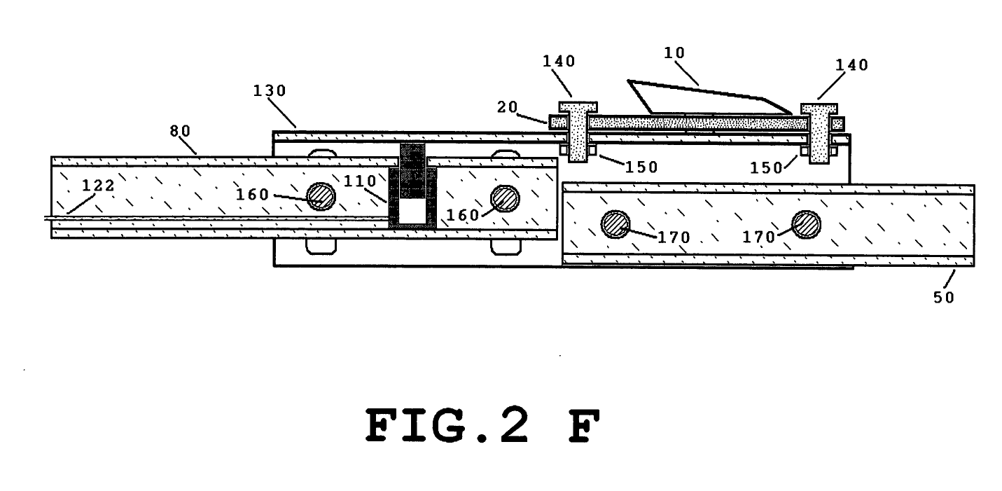

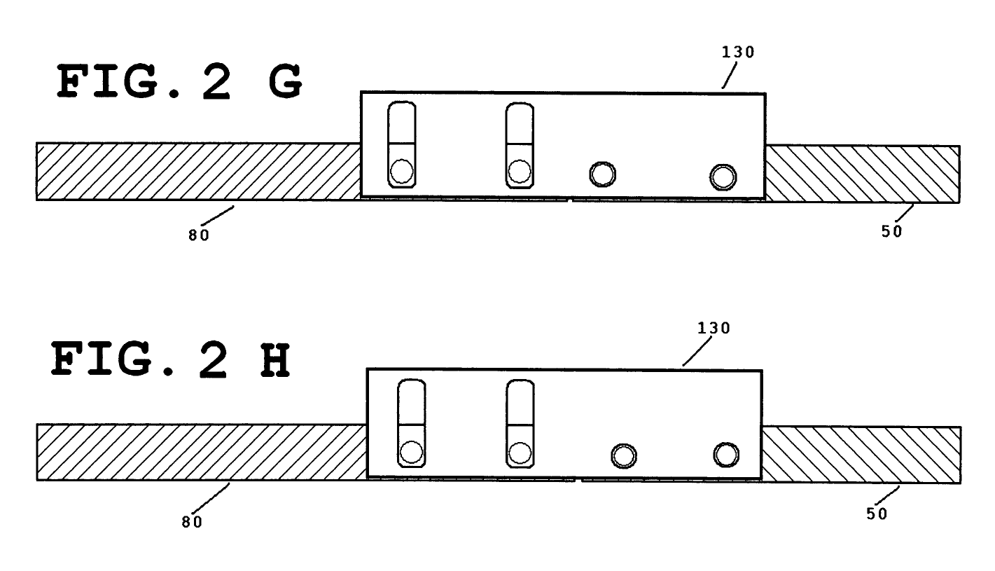

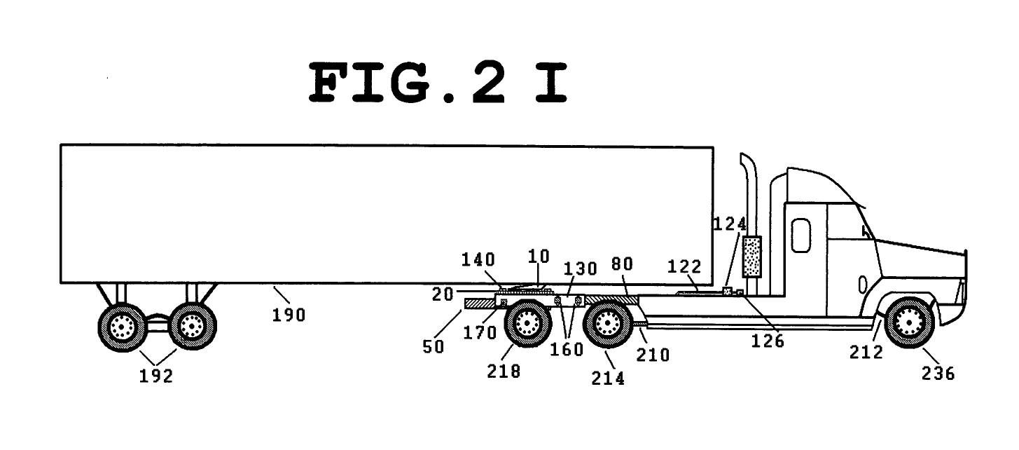

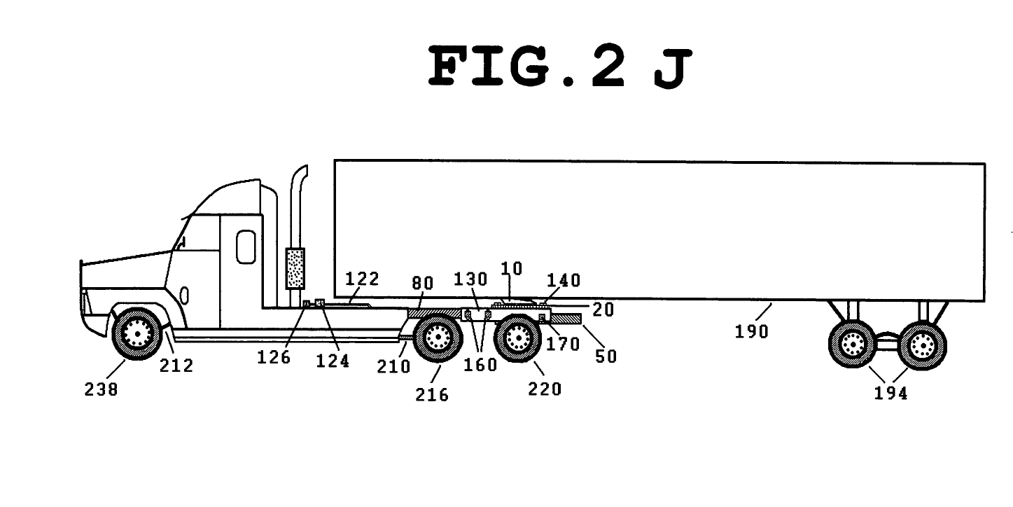

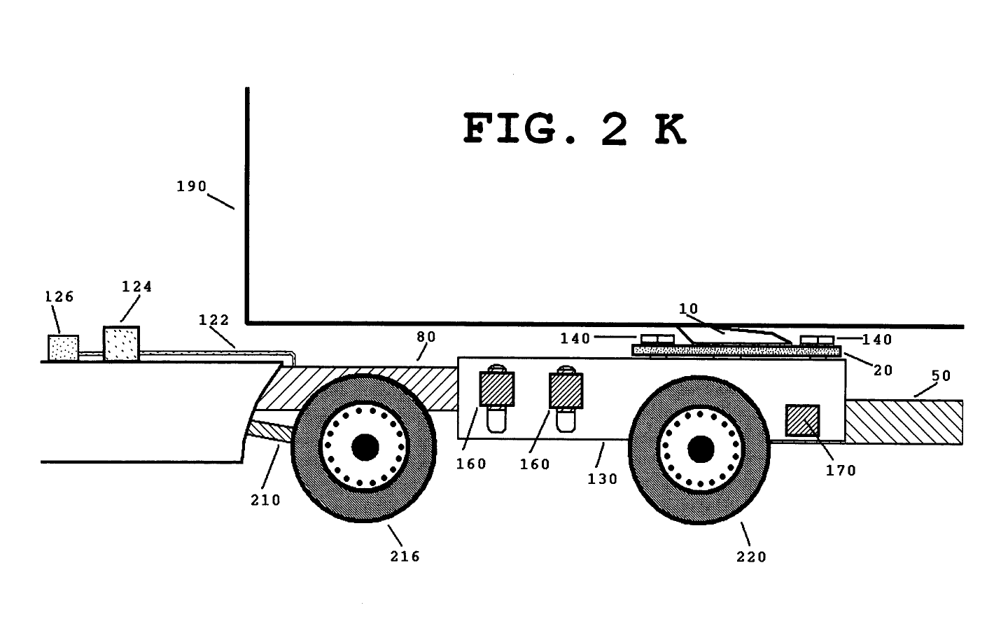

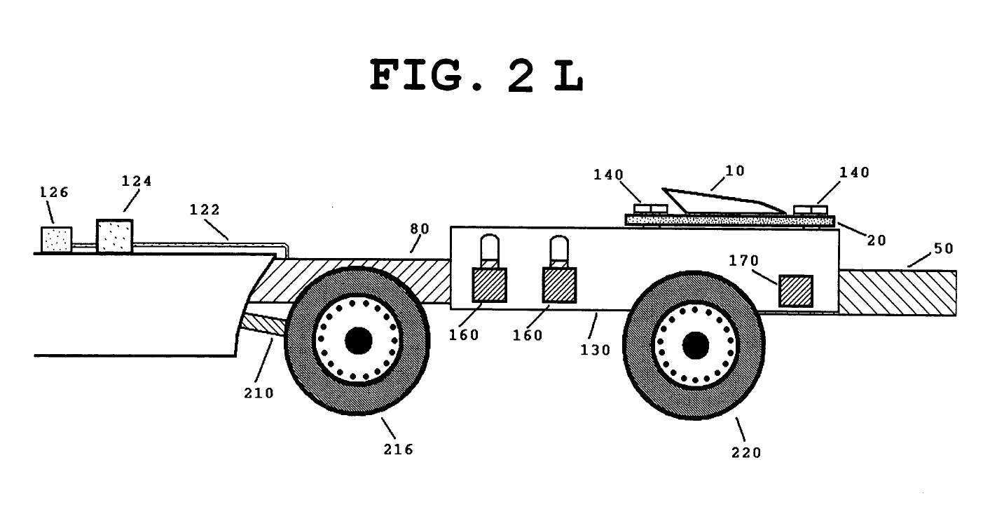

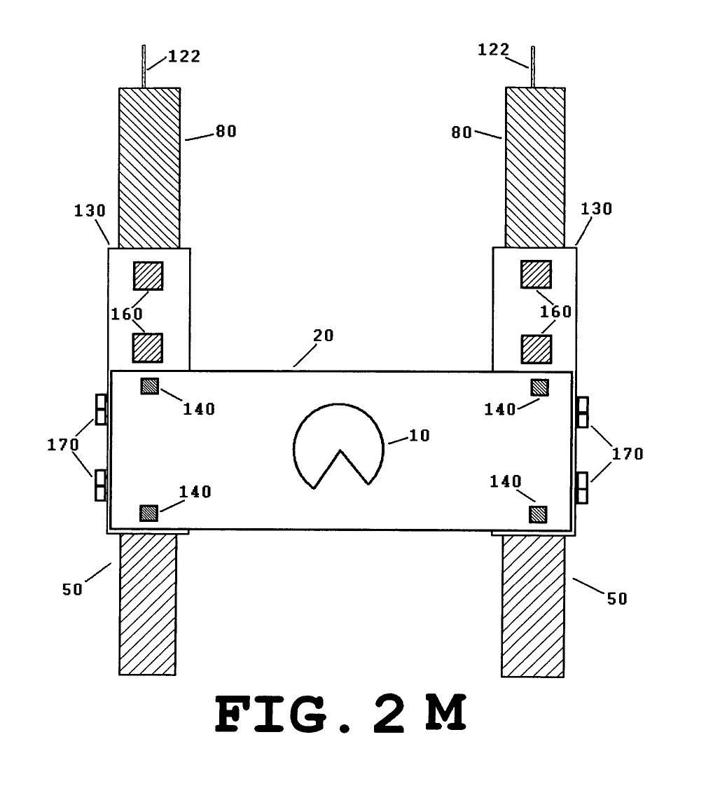

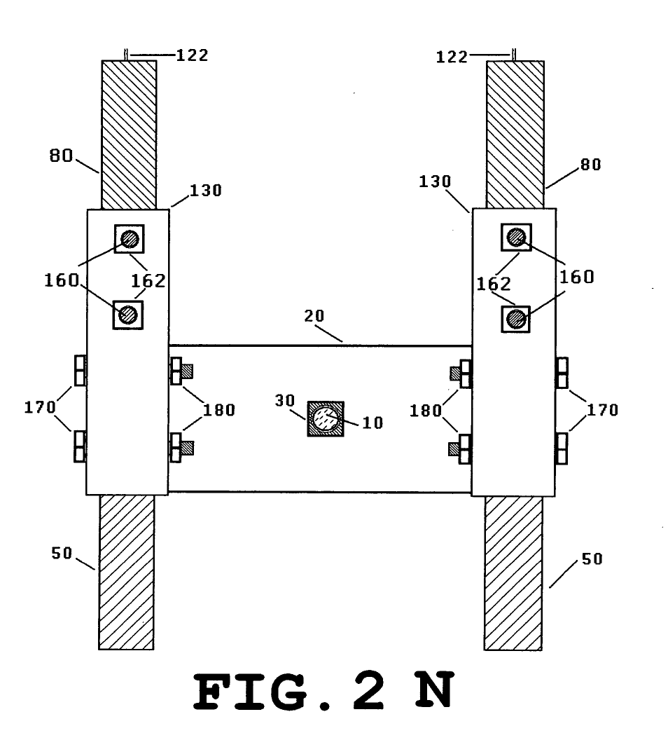

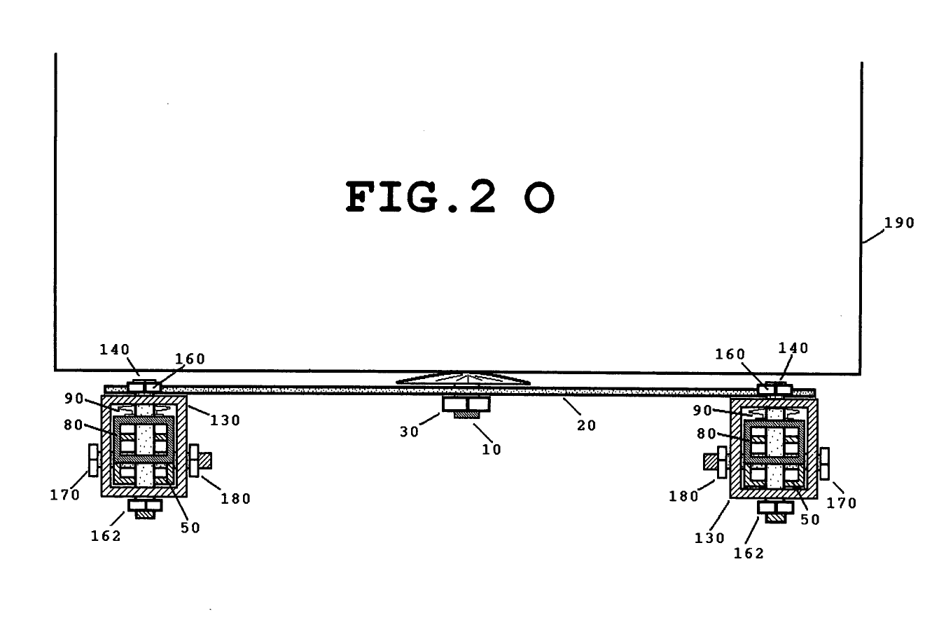

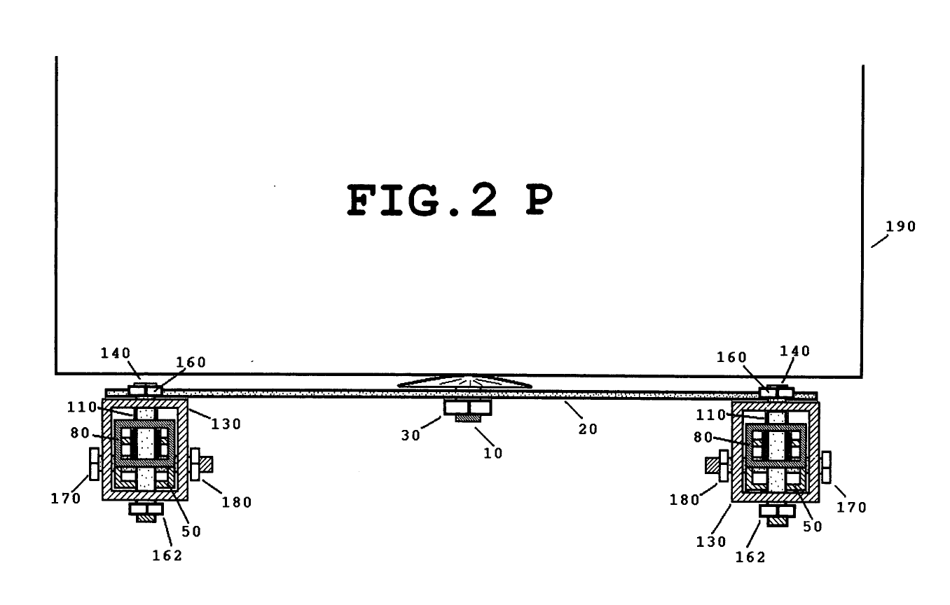

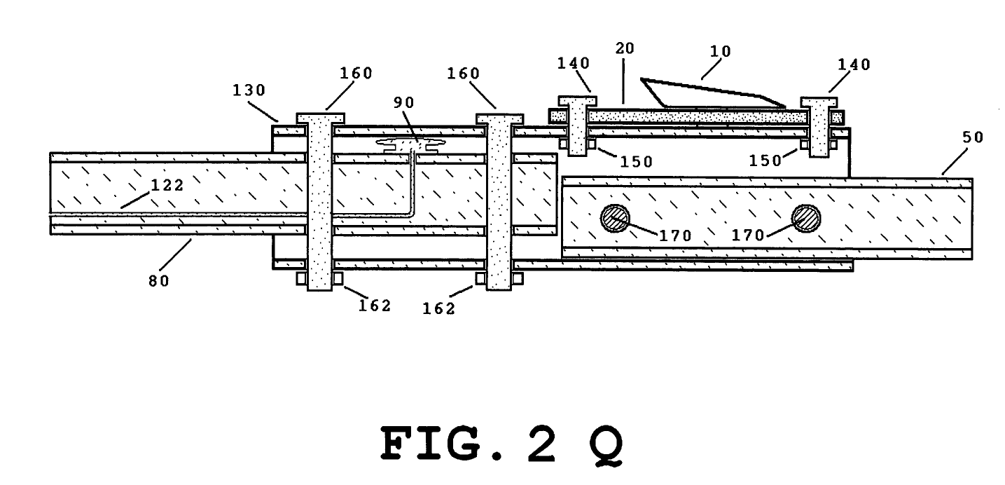

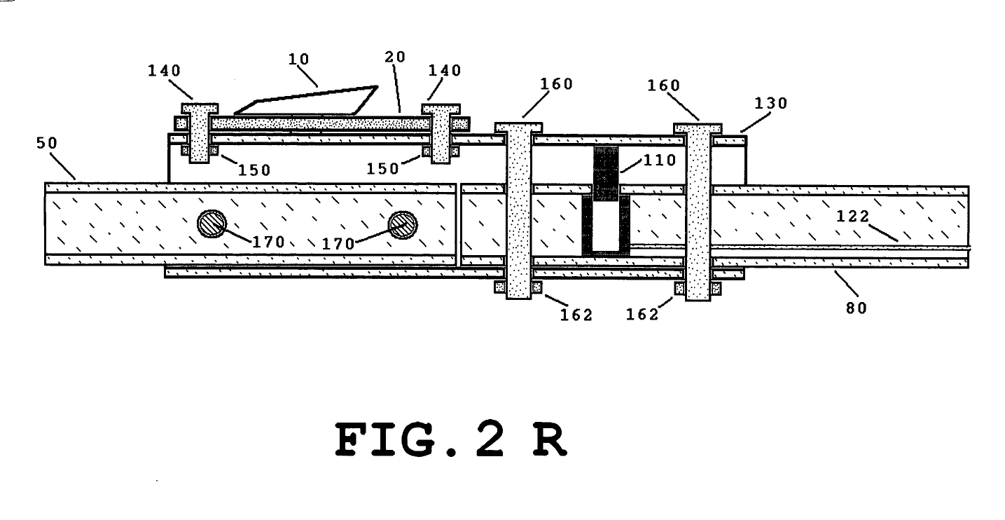

FIG. 1E shows the rearview of the system 100 where the short frames 50 are connected to bridge 20 with bolts 60 and nuts 70. It shows hook 10 connected to the bridge 20 by the hook nut 30. Also seen are the bridge legs 40 connected at which the long frames 80 connected using nuts 120 for holding the long frames 80 and shows the presence of hydraulic jack 110 placed alongside long frames 80. FIG. 1F and FIG. 1G illustrate the presence of airbag 90 and hydraulic jack 110 on and inside long frames 80 from top view. FIG. 1H and FIG. 1I shows the broken side views of bridge 20, bridge legs 40, nuts 120, long frame 80, inflated air bag 90 and deflated hydraulic jack 110. FIG. 1J shows the left side view of system 100 where short frame 50 is connected to the bridge 20 with bolts 60 and nuts 70. It shows bridge legs 40 connected at which the long frame 80 is connected using nuts 120 for holding the long frame 80 and shows the presence of the inflated hydraulic jack 110 inside the long frame 80. FIG. 1K shows the right side view of system 100 where short frame 50 is connected to the bridge 20 with bolts 60 and nuts 70. It shows the bridge legs 40 connected at which the long frame 80 is connected using nuts 120 for holding the long frame 80 and shows the presence of the deflated airbag 90 on the long frame 80. FIG. 2A and FIG. 2B shows another embodiment of the present invention in the rear and front views loaded with airbags wherein the system 200 comprises of the bridge 20 having a specific width and length. The bridge further has a central hole and bolted to a hook 10 using a hook nut 30, and a single hole nearing each corner. A pair of inverse-U shaped extension frames 130 is mechanically coupled to the bridge 20 across said bridge width. The inverse-U shaped extension frames 130 has a square base and a pair of frame legs and the coupling is across the frame base, the coupling means may include bolting using a plurality of bolts 140 and nuts 150. A pair of long frames 80 seated on the bolts 160 inside the inverse-U shaped extension frames 130 thereby preventing long frames 80 from separating away from the inverse-U shaped extension frame 130 and the long frames 80 freely float inside the inverse-U-shaped extension frames. A pair of short frames 50 mechanically coupled tightly inside the inverse-U shaped extension frames 130 by coupling means. In one embodiment, the short frames 50 are mechanically coupled to the inverse-U shaped extension frames 130 with a pair of coupling means at each of the extension frame legs horizontally and the coupling means may include bolting using bolts 170 and nuts 180. In the system 200, a pair of airbags 90 is seated on top of the long frames 80. Also, a pair of hydraulic jacks 110 is placed inside the long frames 80. The pair of airbags 90 and the hydraulic jacks 110 controls the free-floating of the long frames 80 inside the extension frames 130. The airbags 90 and hydraulic jacks 110 may be bolted or welded or glued with the long frames 80. The system 200 is also provided with air tank 124 and hydraulic pump 126 made of known state of art technology for inflating or deflating the airbag 90 or the hydraulic jack 110. A controller is also provided in the system 200 that monitors the load distribution across the axles of the truck and accordingly inflates/deflates the airbag 90 or hydraulic jack 110 and automatically adjusts the load distribution across said truck and trailer assembly. Accordingly, the load of the truck and trailer assembly is spread out on the bridge 20 between the truck and the trailer rather than it sitting on the rear of wheels of the truck.

In another embodiment, the system 200 may be made by cutting an existing frame in half and assembling the components onto the two halves thereby the system 200 may be adapted to existing multi-axle trucks. During the passage of the vehicle going uphill or downhill, the controller inflates/deflates the airbags 90 or the hydraulic jacks 110 using the air tank 124 or hydraulic pump 126 to transform or equalize the load on the wheels of the truck and trailer for traction thereby automatically adjusting load distribution.

FIGS. 2C and 2D shows the top and bottom views of the system 200 of the present invention.

In FIG. 2C, the bridge 20 can be seen on to which the hook 10 is bolted. Plurality of bolts 140 are seen that couples the extension frame 130 to bridge 20. A pair of short frames 50 and long frames 80 is seen coupled inside the extension frame 130. Short frames are coupled to the extension frames 130 by way of the plurality of bolts 170 and nuts 180. A pair of long frames is seated on the plurality of bolts 160 and nuts 162 can be seen coupled inside the extension frame 130. FIG. 2D shows the bottom view of the configuration of the system 200 of the present invention. Hook 10 can be seen bolted to the bridge 20 by way of hook nut 30. A pair of short frames 50 and long frames 80 can be clearly seen coupled to the extension frames 130 using the plurality of bolts and nuts 170, 180 and 160, 162.

The configurations of FIG. 2C and FIG. 2D allow the system 200 to automatically adjusting load distribution. FIG. 2E and FIG. 2F of system 200 show the broken side views of bridge 20, short frame 50, long frame 80, extension frame 130, bolts 140, 160, 170, nuts 150 with deflated airbag 90 and inflated hydraulic jack 110. FIG. 2G and FIG. 2H show the side views of the short frames 50 and the long frames 80 inside the extension frames 130 without bridge 20, hook 10, nut 150 and bolts 140, 160 and 170.

FIG. 2I shows the system 200 assembled in a truck and trailer assembly in the left side view for automatically adjusting load distribution through axles of the truck and trailer assembly. FIG. 2I shows a truck with a drive shaft 210 and truck transition 212. The truck having a left middle truck tire 214 and last rear truck tire 218. A trailer 190 is shown having left side trailer tires 192. The trailer 190 is received on the hook 10 of the system 200. The extension frame 130 is seen in the side view having bolts 170 fixing the short frame 50 to the extension frame and bolts 160 bolting in the long frames 80 to the extension frame 130. FIG. 2J shows the system 200 assembled in a truck and trailer assembly in the right side view for automatically adjusting load distribution through axles of a truck and trailer assembly. FIG. 2J shows a truck is shown having right middle truck tire 216 and right rear truck tire with 220 and the trailer 190 with right side trailer tires 194.

The extension frame 130 is connected on the right side to the short frames 50 by the way of bolts 170 and to the long frames 80 by means of the bolts 160. The system receives the trailer 190 on the hook 10 and accordingly the vehicle moves uphill or downhill, the airbags 90 and the hydraulic jacks 110 get inflated/deflated and transform/equalize the load on the wheel for traction and spreads out the load on the bridge 20 and the extension frame 130 between the truck and trailer 190 rather than it sitting on the rear wheels 218 and 220 of the truck. FIG. 2K shows and an enlarged view of assembly 200 in conjunction with the truck and trailer assembly receiving the loaded trailer 190 on the hook 10 of the system 200. FIG. 2L shows an enlarged side view of the truck without trailer 190 of the system 200. FIG. 2M and FIG. 2N show another variation of the system 200 having a different configuration of the extension frame 130 in the top and bottom views. The bridge 20 is bolded in the same manner to the extension frame 130 by means of a plurality of bolts 140. The extension frame 130 receives within the short frame 50 by way of the bolts 170 and nuts 180 and the long frame 80 are similar connected to the extension frames 130 by means of bolts 160 and nuts 162. FIG. 2O shows the front view of the system 200 loaded with airbags 90 upon the long frames 80 and receiving the trailer 190 on the hook 10. FIG. 2P shows a similar embodiment of the system 200 loaded with a hydraulic jack 110 within a long frames 80. FIG. 2Q and FIG. 2R of system 200 show the broken side views of the bridge 20, extension frame 130, long frame 80, short frame 50, bolts 140, 160, 170 and nuts 150, 162 with deflated airbag 90 and inflated hydraulic jack 110.

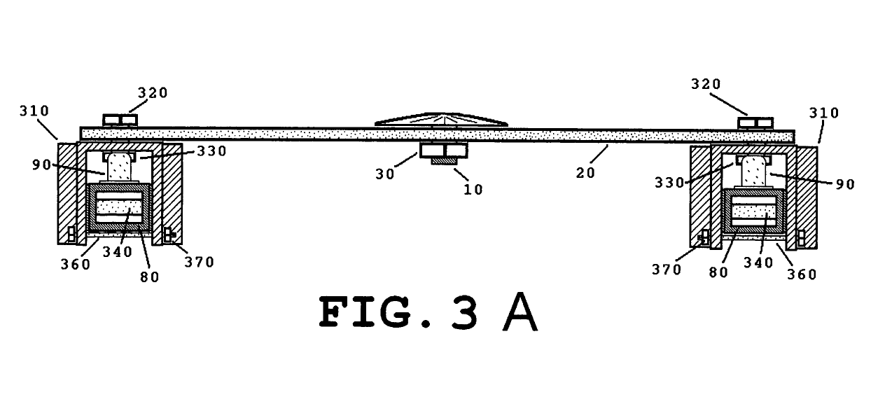

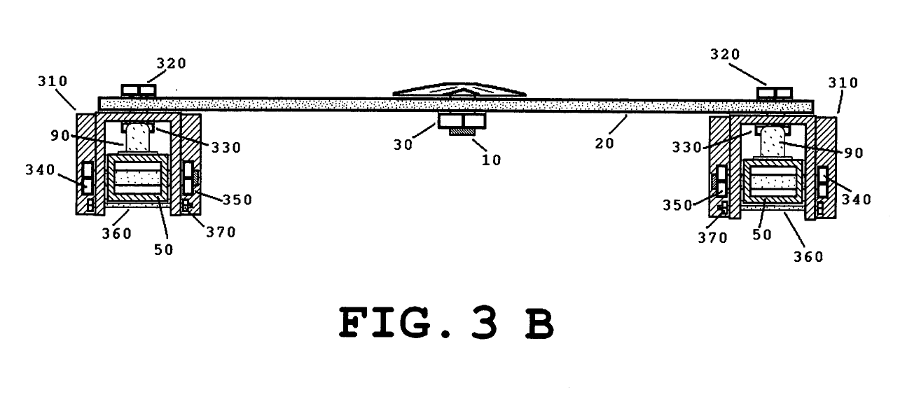

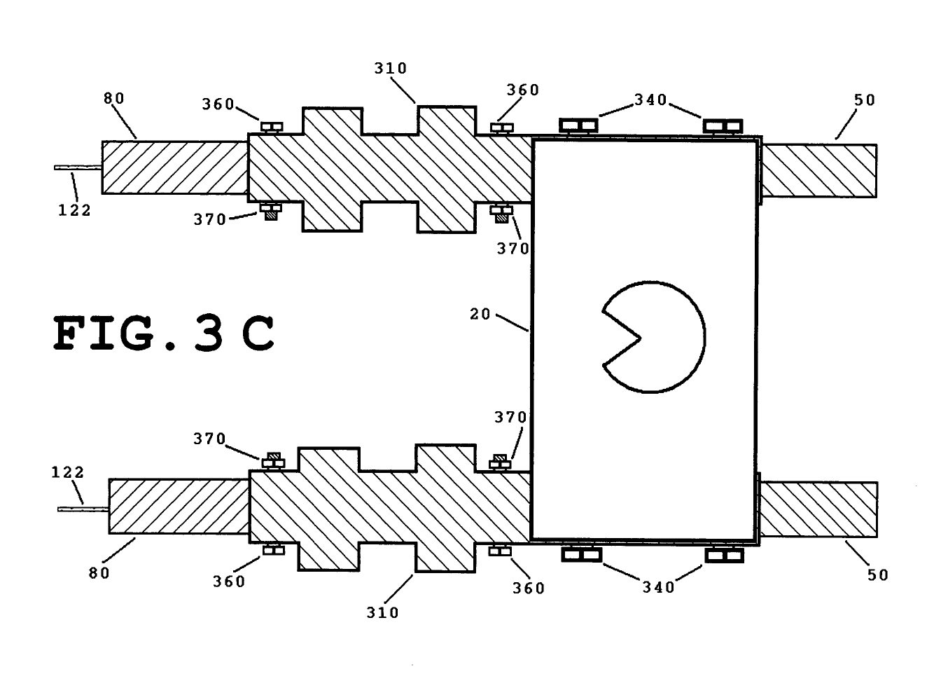

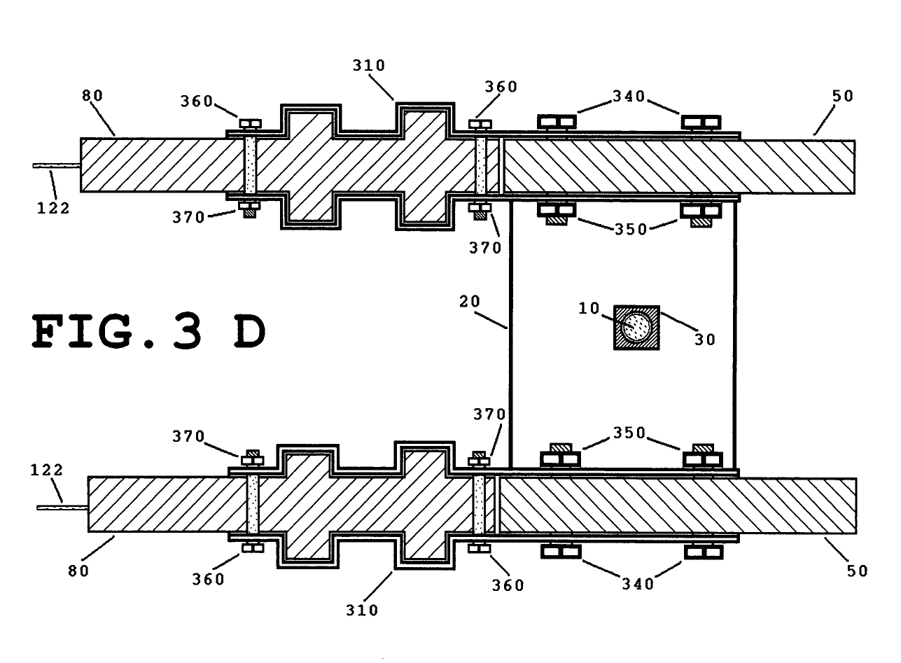

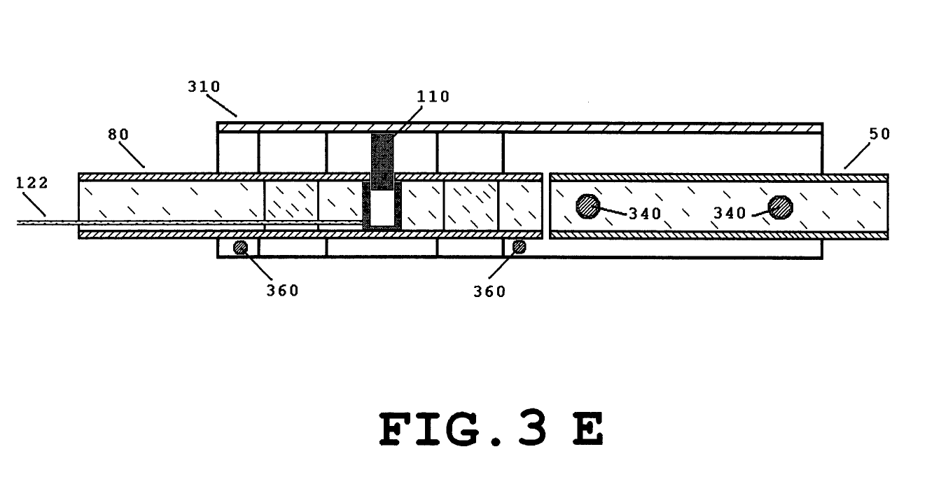

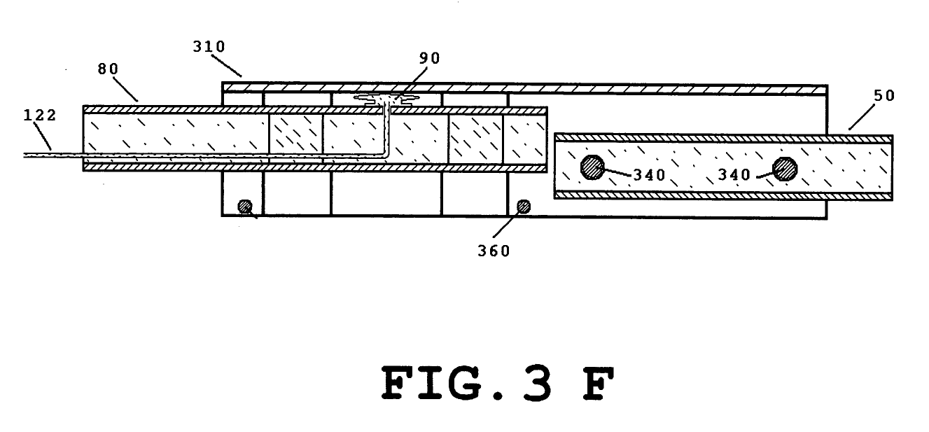

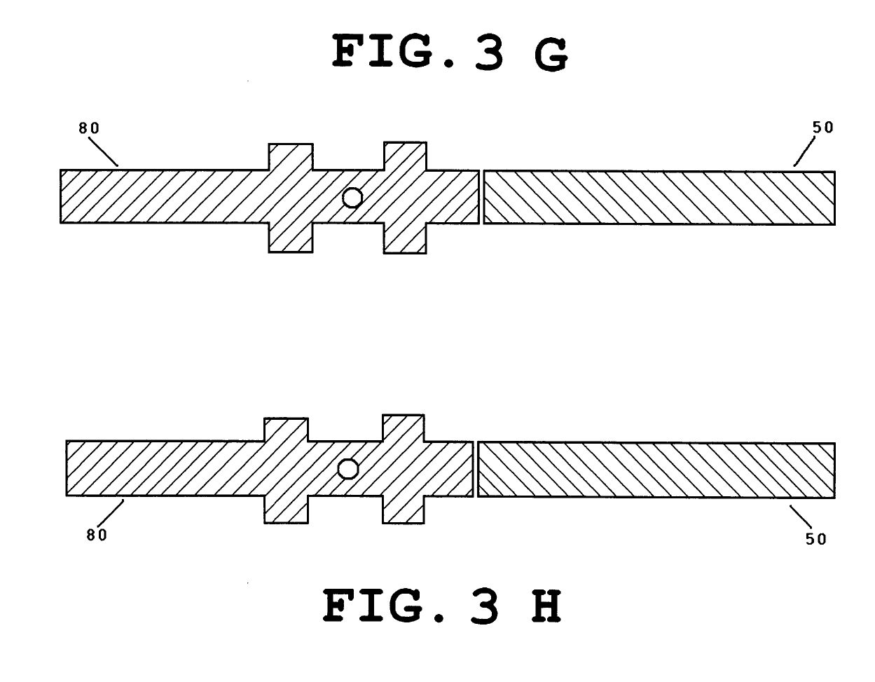

In yet another embodiment, shown herein in FIGS. 3A and 3B is system 300 of the present invention in the front and rear views wherein the system 300 comprises of the bridge 20 having a specific width and length. The bridge further has a central hole and bolted to the hook 10 using a hook nut 30 and a hole nearing each corner. A pair of hollow cuboidal shaped extension frames 310 is mechanically coupled to the bridge 20 across said bridge width. The hollow cuboidal shaped extension frames 310 has a square base on the opposite sides and a pair of front legs and the coupling is across the frame base to the bridge 20, the coupling means may include bolting using a plurality of bolts 320 and nuts 330.

A pair of long frames 80 seated inside the hollow cuboidal shaped extension frames 310 and float freely inside the hollow cuboidal shaped extension frames. A pair of short frame 50 mechanically coupled tightly inside the hollow cuboidal shaped extension frames 310 by coupling means. In one embodiment, the short frames 50 are mechanically coupled to the hollow cuboidal shaped extension frames 310 with a pair of coupling means at each of the extension frame leg horizontally and the coupling means may include bolting using bolts 340 and nuts 350.

The bolt 360 and nut 370 prevents long frame 80 from separating from the hollow cuboidal shaped extension frame 310. The suspension of the front and middle tires 236, 238, 214 and 216 sit on the long frames 80, and the suspension of the rear tires 218 and 220 sit on the short frames 50, bridge 20, extension frame 130 and hollow cuboidal shaped extension frame 310.

FIGS. 3C and 3D shows the top and bottom view of the system 300 having the bridge 20 in conjunction with the hollow cuboidal shaped extension frame 310. FIG. 3E and FIG. 3F show the broken side views of the bridge 20, hollow cuboidal shaped extension frame 310, short frame 50, long frame 80, bolts 320, 340, 360 and nuts 330, 370 with inflated hydraulic jack 110 and deflated airbag 90. FIG. 3G and FIG. 3H show the top views of the left and right short frames 50 and long frames 80 of the system 300. The system of 300 is also provided with an air tank 124 and hydraulic pump 126 made of known state of the art technology for inflating or deflating the airbag 90 or the hydraulic jack 110.

A controller is also provided in the system 300 that monitors the load distribution across the axles of the truck and accordingly inflates/deflates the airbag 90 or hydraulic jack 110 and automatically adjusts a load distribution across the truck and trailer assembly. Accordingly, the load of the truck and trailer assembly is spread out on the bridge 20 between the truck and trailer rather than it sitting on the rear wheels of the truck. The forgoing descriptions of specific embodiments of the present invention have been presented for purposes of illustration and description.

They're not intended to be exhaustive or to limit the invention to the precise forms disclosed, and obviously many modifications and variations are possible in light of the above teachings. The embodiments were chosen and described in order to best explain the principles of the invention and its practical application to thereby enable others skilled in the art to best utilize the invention and various embodiments with various modifications as are suited to the particular use contemplated. It is understood that various omissions, substitutions of a equivalent are contemplated as circumstance may suggest or render expedient, but is intended to cover its the application or implementation without departing from the spirit or scope of the claims of the present invention.

1. A system for automatically adjusting load distribution through axles of a truck and trailer assembly having a pair of rear wheels, the system comprising:
a bridge section having a width, a length, a plurality of bridge legs coupled to it using a coupling means, a central hole bolted to a hook using a hook nut and a hole nearing each corner;
a pair of short frames running parallel to said bridge width and being connected to said bridge through said coupling means;
a pair of long frames running alongside said short frames, having a plurality of holes equinumber to said plurality of bridge legs, said holes configured to receive said bridge legs, said bridge legs being tightened to said holes using tightening means at an end opposite to said bridge, said long frames being free-floating frames;
a pair of airbags seated on top of said long frames;
a pair of hydraulic jacks placed inside said long frames; said pair of airbags and hydraulic jacks control the free-floating of said long frames;
an air tank or a hydraulic pump for inflating or deflating said airbag or said hydraulic jack; and
a controller configured for monitoring said load distribution across said axles and inflates/deflates said airbag or hydraulic jack thereby automatically adjusting load distribution across said truck and trailer assembly.

2. A system for automatically adjusting load distribution through axles of a truck and trailer assembly of claim 1, wherein said coupling means may include bolt and nut passing through said holes nearing each corner.

3. A system for automatically adjusting load distribution through axles of a truck and trailer assembly of claim 1, wherein said bridge legs may have threads configured to be threaded onto said bridge holes.

4. A system for automatically adjusting load distribution through axles of a truck and trailer assembly of claim 1, wherein said tightening means may include screws for screwing said long frames with said bridge legs thereby preventing the separation of said long frames from said bridge legs.

5. A system for automatically adjusting load distribution through axles of a truck and trailer assembly of claim 1, wherein said bridge and said bridge legs may be one-piece metal or the like.

6. A system for automatically adjusting load distribution through axles of a truck and trailer assembly of claim 1, wherein said airbags and hydraulic jacks may be bolted or welded or glued with said long frames.

7. A system for automatically adjusting load distribution through axles of a truck and trailer assembly of claim 1, wherein said bridge may also as be welded with said short frames or may be one-piece metal or the like.

8. A system for automatically adjusting load distribution through axles of a truck and trailer assembly of claim 1, wherein said load of said truck and trailer assembly is spread out on said bridge between said truck and trailer rather than it sitting on the rear wheels of said truck.

9. A system for automatically adjusting load distribution through axles of a truck and trailer assembly of claim 1, wherein said apparatus may be made by cutting an existing frame in half and assembling the components onto the two halves thereby said system may be adapted to existing multi-axle trucks.

10. A system for automatically adjusting load distribution through axles of a truck and trailer assembly of claim 1, wherein said controller inflates/deflates said to airbags/hydraulic jacks using said air tank or hydraulic pump to transform/equalize said load on said wheels for traction while going uphill or down hill.

11. A system for automatically adjusting load distribution through axles of a truck and trailer assembly having a pair of real wheels, the system comprising:
a bridge section having a width and a length, a central hole bolted to a hook using a hook nut, and a pair of holes nearing each corner;
a pair of extension frames mechanically coupled to said bridge across said bridge width; a pair of long frames seated on a bolt inside said extension frames thereby preventing long frames from separating away from said extension frames, the long frames freely float inside said extension frames:
a pair of short frames mechanically coupled tightly inside said extension frames; a pair of airbags seated on top of said long frames;
a pair of hydraulic jacks placed inside said long frames, said pair of airbags and hydraulic jacks control the free flowing of said long frames inside said extension frames;
an air tank or hydraulic pump for inflating or deflating said airbag or hydraulic jack; and
a controller configured for monitoring said load distribution across said axles and inflates/deflates said airbag or hydraulic jack thereby automatically adjusting load distribution across said truck and trailer assembly.

12. A system for automatically adjusting load distribution through axles of a truck and trailer assembly as claimed in claim 11, wherein said extension frames may be inverse U-shaped having a square base and a pair of frame legs.

13. A system for automatically adjusting load distribution through axles of a truck and trailer assembly as claimed in claim 11, wherein said extension frame may be of the structure having base such on opposite sides connected by legs forming a hollow cuboid.

14. A system for automatically adjusting load distribution through axles of a truck and trailer assembly as claimed in claim 11, wherein said short frames are mechanically coupled to said extension frames with a pair of coupling means at each said extension frames with a pair of coupling means at each said extension frame leg horizontally, said coupling means may include bolting using bolts and nuts.

15. A system for automatically adjusting load distribution through axles of a truck and trailer assembly as claimed in claim 11, wherein said extension frames are coupled to said bridge at said base and the frame legs extending vertically downward from said bridge.

16. A system for automatically adjusting load distribution through axles of a truck and trailer assembly as claimed in claim 11, wherein said airbags and hydraulic jacks may be bolted or welded or glued with said long frames.

17. A system for automatically adjusting load distribution through axles of a truck and trailer assembly as claimed in claim 11, wherein said load of said truck and trailer assembly is spread out on said bridge and extension frame between said truck and trailer rather than it sitting on the rear wheels of said truck.

18. A system for automatically adjusting load distribution through axles of a truck and trailer assembly as claimed in claim 11, wherein said apparatus may be made by cutting an existing frame in half and assembling the components onto the two halves thereby said system may be adapted to existing multi-axle trucks.

19. A system for automatically adjusting load distribution through axles of a truck and trailer assembly as claimed in claim 11, wherein said controller inflates/deflates said to airbags/hydraulic jacks using said air tank/hydraulic pump to transform/equalize said load on said wheels for traction while going uphill or downhill.

20. A system for automatically adjusting load distribution through axles of a truck and trailer assembly as claimed in claim 13, wherein said system further includes a bolt and a nut to prevent one of said pair of long frames and said hollow cuboidal from separating.

21. A system for automatically adjusting load distribution through axles of a truck and trailer assembly as claimed in claim 13, wherein said system includes a first suspension for front and middle tires to sit on said long frames and a second suspension for rear tires to sit on said short frame, said bridge, said extension frames and said hollow cuboidal.
